(19) United States
(12) Patent Application Publication
(10) Pub. No.: US 2026/0056708 A1
(43) Pub. Date: Feb. 26, 2026

(54) Pipelined Floating-Point Adder with Support for Forwarding Un-Normalized Mantissa Results for Dependent Instructions

(71) Applicant: Apple Inc., Cupertino, CA (US)

(72) Inventors: Evan R. Lissoos, Austin, TX (US); Anurag Choudhury, Austin, TX (US)

(21) Appl. No.: 18/812,518

(22) Filed: Aug. 22, 2024

(51) Int. Cl. G06F 7/485; G06F 1/04

(52) U.S. Cl. CPC G06F 7/485; G06F 1/04

(57) ABSTRACT

Techniques are disclosed relating to floating-point add pipelines. In some embodiments, floating-point add pipeline circuitry configured to perform a first add operation followed by a second add operation, where the second add operation specifies a first input operand that corresponds to a result of the first add operation. Adder circuitry may add mantissa values to generate a mantissa result. Forward circuitry may forward an un-normalized mantissa result from the adder circuitry as an input operand for the second add operation and exponent information from the first add operation. Left-shift circuitry may, prior to the adder circuitry in the pipeline, left-shift the un-normalized mantissa result based on the exponent information. The adder circuitry may add the shifted mantissa result for the second add operation. Disclosed techniques may allow execution of dependent add instructions, in a two-stage pipeline, without bubbles.

### BACKGROUND

### Technical Field

This disclosure relates generally to computer processors and more particularly to floating-point adder circuitry.

### Description of Related Art

Computer processors are often configured to perform various floating-point operations, including add operations. Adders may be pipelined, e.g., with two or three stages. Traditionally, two dependent floating-point additions (where one operates on the output of the other) may cause bubbles in the adder pipeline where one add operation waits on the result of the other add operation. Pipeline bubbles reduce performance, relative to keeping the pipeline full.

### BRIEF DESCRIPTION OF DRAWINGS

FIG. 1 is a block diagram illustrating example floating-point adder circuitry with a forwarding path for an intermediate mantissa result, according to some embodiments.

FIG. 2 is a block diagram illustrating a more detailed example of floating-point adder circuitry with a forwarding path for an intermediate mantissa result, according to some embodiments.

FIG. 3 is a block diagram illustrating a more detailed example of floating-point adder circuitry that shares left-shift circuitry for handling forwarded intermediate results and generating a final result, according to some embodiments.

FIG. 4 is a flow diagram illustrating an example method, according to some embodiments.

FIG. 5 is a block diagram illustrating an example computing device, according to some embodiments.

FIG. 6 is a diagram illustrating example applications of disclosed systems and devices, according to some embodiments.

FIG. 7 is a block diagram illustrating an example computer-readable medium that stores circuit design information, according to some embodiments.

### DETAILED DESCRIPTION

Floating-point adders are often implemented using multiple pipeline stages. When a younger add depends on a result from an older add, this may introduce pipeline bubbles that reduce performance. Compilers may address this issue by inserting other instructions in between dependent instructions to avoid bubbles. But this may be undesirable (e.g., because of reduced performance if the dependent instruction is on the critical path) or independent add operations may not be available for certain workloads (e.g., when accumulating a stream of inputs).

Therefore, in disclosed embodiments discussed in detail below, a two-stage adder is configured to execute dependent floating-point add instructions sequentially without any pipeline bubbles. In particular, the pipeline may forward un-normalized results from an older instruction (e.g., an intermediate mantissa result prior to normalization, an anchor exponent, an overflow result, and leading-zero anticipator information). Generally, forwarding refers to sending information to a previous pipeline stage for use by a subsequent operation. Forwarding the mantissa value prior to normalization may allow for appropriate left-shifting for use by the younger, dependent instruction in parallel with right-shifting for the younger instruction. This may effectively hide the latency of normalization for the older instruction (which would traditionally introduce a pipeline bubble). Generally, disclosed techniques may advantageously provide timing benefits of a pipelined arithmetic logic unit (ALU) with dependency benefits of a single-cycle ALU.

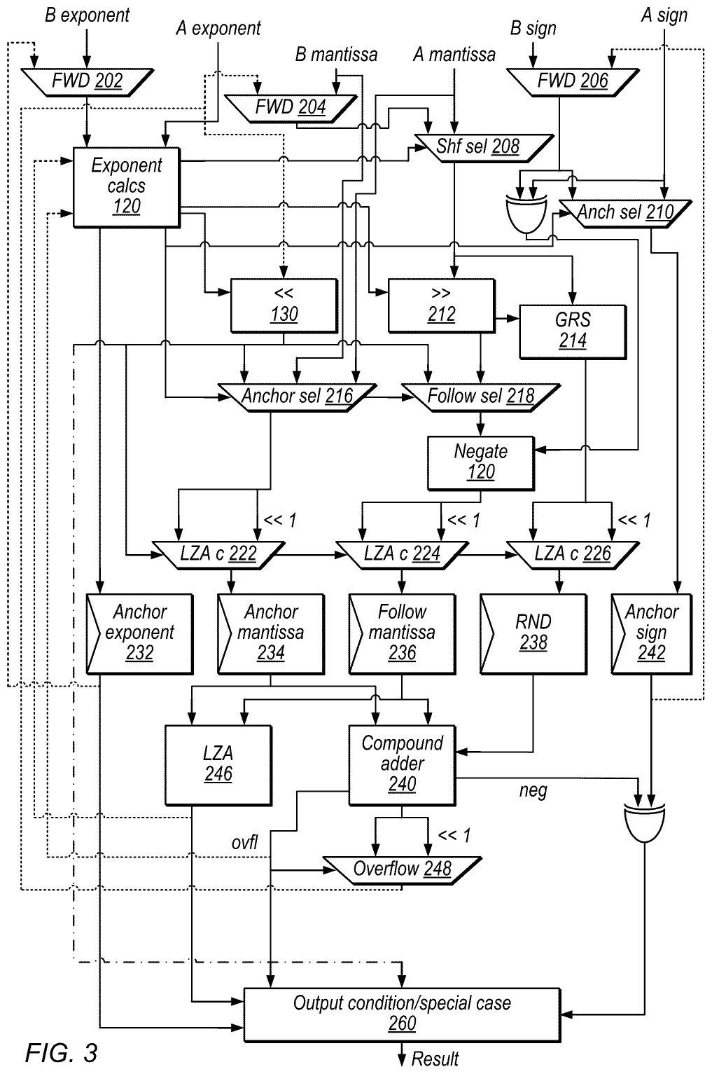

In some embodiments, the left-shifter that operates on un-normalized results may be shared with traditional non-forwarding left-shift operations to avoid adding a left-shifter (e.g., in applications where a forwarded result will not be needed other than as an input for the dependent add), as discussed below with reference to FIG. 3. In some embodiments, the pipeline includes control circuitry to correct leading zero anticipation (LZA) outputs, if needed, in the forwarding context.

Disclosed techniques may advantageously allow sequential execution of dependent add operations without pipeline bubbles (or with reduced bubbles), improving performance for certain workloads with limited increases in area and power consumption, in various embodiments.

### Overview of Adder with Forward Path for Intermediate Mantissa Results

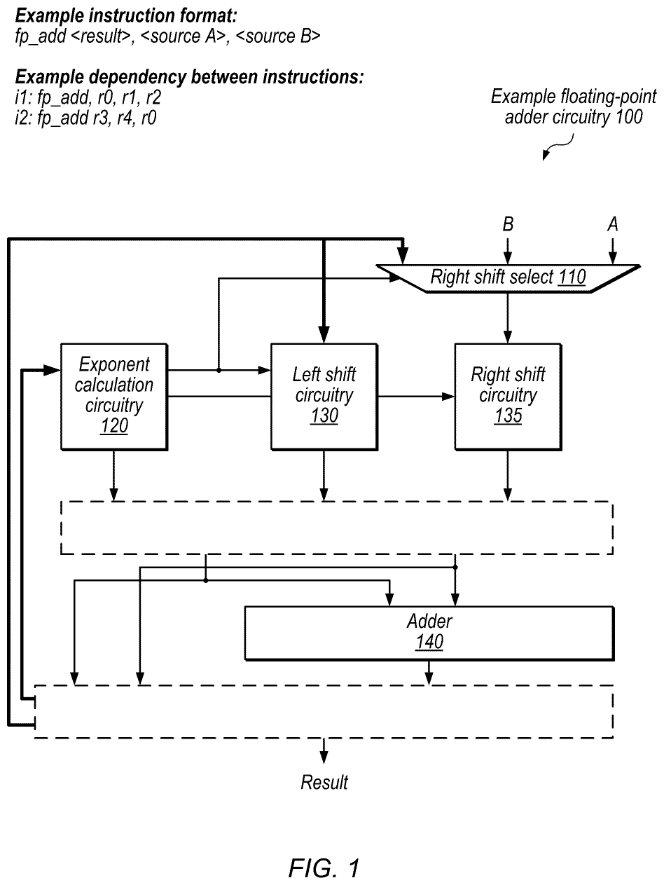

FIG. 1 is a block diagram illustrating example floating-point adder circuitry with a forwarding path for an intermediate mantissa result, according to some embodiments. In the illustrated example, adder circuitry 100 includes right-shift select 110 (e.g., a multiplexer), exponent calculation circuitry 120, left-shift circuitry 130, right-shift circuitry 135, and adder circuitry 140 (e.g., an integer compound adder configured to operate on input mantissa values).

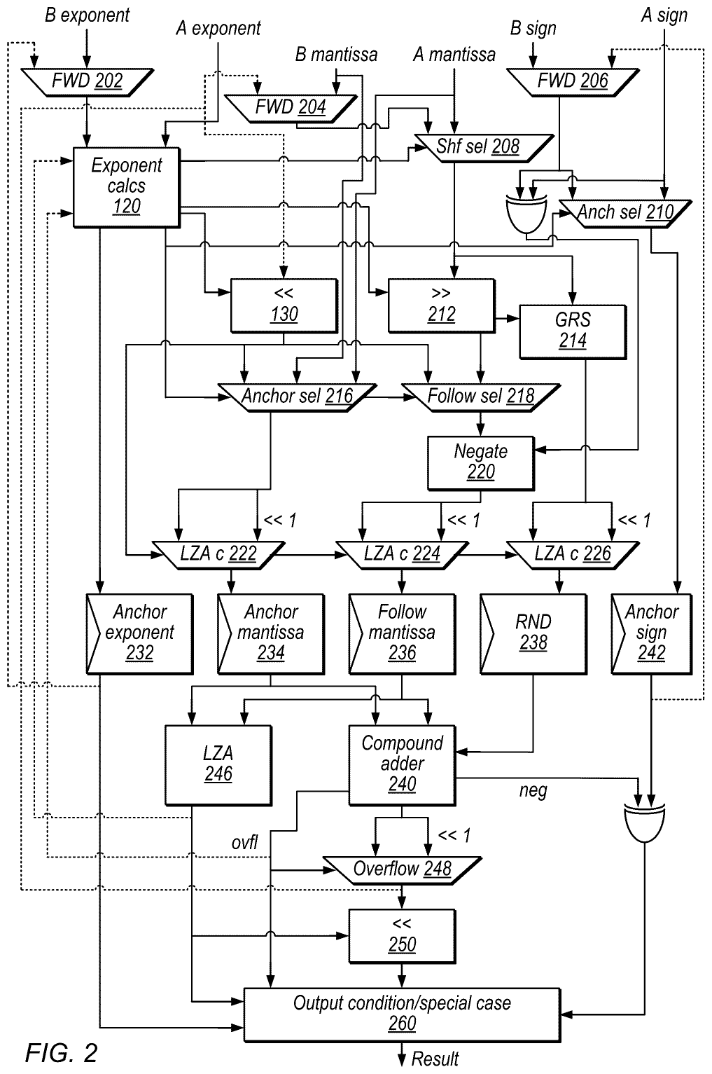

FIG. 1 also includes dashed blocks to illustrate other adder control operations that may be implemented using various circuitry, e.g., to handle anchor/follow selection, rounding, negation, leading zero operations, overflow handling, special case handling, etc. FIG. 2 provides detailed examples of such circuitry, but these operations may be implemented using various circuits in different embodiments.

In the illustrated example, a floating point add operation (shown as an “fp_add” instruction) indicates a result operand and two input operands A and B. FIG. 1 also shows an example instruction sequence in which instruction i2 is dependent on instruction i1 (because i1's result r0 is used as the B input operand for i2). As discussed above, traditionally these instructions might utilize a bubble in adder circuitry 100 or a compiler might attempt to schedule another instruction between them. In disclosed embodiments, however, forward select circuitry may select intermediate results from instruction i1 (associated with r0) instead of the B operand for instruction i2, which may allow i2 to launch execution in the cycle immediately following the cycle in which i1 launched execution, without any bubbles. In particular, intermediate results based on the output of adder 140 may be forwarded to right-shift select 110, left-shift circuitry 130, and exponent calculation circuitry 120, as discussed in detail below.

Adder circuitry 140, in the illustrated embodiment, is configured to add mantissa values associated with the A and B operands for instructions without forwarding. For instructions with forwarding, adder circuitry 140 is configured to add the mantissa value associated with the A operand with a mantissa associated with a forwarded intermediate result. Adder circuitry 140 may implement one or more of various topologies, such as ripple carry, carry save, carry lookahead, parallel prefix, compressors, etc. Adder circuitry 140 may be implemented using various underlying logic circuits, e.g., XOR/AND gates, NAND gates, etc. In the illustrated example, adder circuitry 140 provides an add result that is an un-normalized mantissa value for further processing by circuitry representing the dashed box to generate a final add result. In the illustrated example, this circuitry also forwards the un-normalized, intermediate mantissa value (e.g., after overflow handling in some embodiments) back to left-shift circuitry 130 and right-shift select circuitry 110. Note that normalization is well understood in the context of floating-point circuitry refers to shifting the mantissa of a number so that the first digit to the left of the binary point is one (this digit is typically implied) and correspondingly updating the exponent.

Right-shift select circuitry 110 is configured to select either a mantissa from the forwarded intermediate mantissa result, the B input operand, or the A input operand depending on whether an instruction is receiving a forwarded result from a prior instruction and the relationships between the exponents of the A input operand and the other operand (either the B operand or the forwarded result).

Exponent calculation circuitry 120, in the illustrated embodiment, is configured to determine an amount to left shift the forwarded un-normalized mantissa result for forwarding operations, e.g., to potentially perform a left-shift on a forwarded intermediate mantissa to provide a mathematically correct result. Therefore, exponent calculation circuitry 120 may control left-shift circuitry 130 in part based on a forwarded exponent result. Exponent calculation circuitry 120 is also configured to control right-shift select circuitry 110 and right-shift circuitry 135 to right-shift the selected mantissa.

In various embodiments, performing the left shift by circuitry 130 (if needed for a forwarded intermediate result) and the right shift by circuitry 135 at least partially in parallel, in the same pipeline stage, may advantageously hide the latency of normalization operations (e.g., relative to waiting for normalization of the forwarded value, which may introduce a pipeline bubble).

In various embodiments, the forwarding path to right-shift select circuitry 110 and the left-shift circuitry may advantageously allow sequential execution of dependent floating-point add instructions, without bubbles, in a two-stage pipeline. Note that left-shift circuitry 130 may be added to an existing design or may be shared for both left-shifting forwarded values and generating the final result (in embodiments in which execution of a given instruction will need to generate only a forwarded intermediate value or a result operand, but not both), as discussed in detail below with reference to FIG. 3.

### Detailed Example Adder Implementation

FIG. 2 is a block diagram illustrating a more detailed example of floating-point adder circuitry with a forwarding path for an intermediate mantissa result, according to some embodiments. In the illustrated example, adder circuitry 100 includes: exponent calculation circuitry 120, left-shift circuitry 130, compound adder 240, forward select circuitry 202, 204, and 206, shift select circuitry 208, anchor select circuitry 210 and 216, right-shift circuitry 212, follow select circuitry 218, negate circuitry 220, leading-zero anticipator correction circuitry 222, 224, and 226, storage circuitry such as latches between pipeline stages (for anchor exponent 232, anchor mantissa 234, follow mantissa 236, round information 238, and anchor sign 242), leading zero anticipator circuitry 246, overflow circuitry 248, two exclusive OR (XOR) gates, left-shift circuitry 250, and output condition/special case handling circuitry 260.

Forward circuitry 202, in the illustrated example, is configured to select between a forwarded exponent from anchor exponent storage 232 and the exponent of the B operand, based on whether forwarding is used for the add. Similarly, forward circuitry 204 is configured to select between a forwarded intermediate mantissa generated by overflow circuitry 248 and the B mantissa and forward circuitry 206 is configured to select between the B sign and the sign from anchor sign storage 242. Generally, the forward select circuitry may select the B operand inputs when a given operation is not using forwarded results.

Exponent calculation circuitry 120, in the illustrated embodiment, is configured to receive two input exponents (the A exponent and either the B exponent or a forwarded exponent), a result from leading zero anticipator 246, and an overflow indicator from overflow circuitry 248 (where the last two inputs may be considered only for forwarding operations). Exponent calculation circuitry 120 controls shift select 208, left-shifter 130, right-shifter 212, anchor select 216, and follow select 218 based on these inputs.

Note that the anchor select circuit 216 has three inputs in this example. In other embodiments, one of the inputs may be removed, e.g., by providing the output of forward select 204 to left shift circuitry 130 and removing the B mantissa input to anchor select 216. In these embodiments, when not forwarding, forward select 204 may select the B mantissa input and circuitry 120 may control left-shifter 130 not to shift at all, passing the B mantissa input to the left leg of anchor select 216.

The following set case analysis provides example control signaling by circuitry 120 in various situations, ignoring subnormals to simplify explanation (although subnormals may be supported using additional control circuitry in various embodiments). In this disclosure, the terms “anchor” and “follow” are used where the follow term is the term being shifted for alignment based on exponent differences. Circuitry 120 may determine the anchor term based on the incoming exponents and control shift select 208, anchor select 216, and follow select 218 accordingly.

In the set case analysis below the “B” term refers to either the B operand or a forwarded operand depending on whether the operation is using a forwarded result.

In the normal case with no forwarding, or forwarding without overflow or cancelation, the anchor does not need a shift and the follow needs a right shift (e.g., by circuitry 212). In this case, the following operations may determine the follow/anchor and the right shift amount:

$$follow = A . exp >= B . exp ? B : A$$

$$anchor = A . exp >= B . exp ? A : B$$

$$rshf\_amt = \vert A . exp - B . exp \vert$$

In the case of forwarding with overflow, the anchor does not shift and the follow needs a right shift (e.g., by circuitry 212):

$$follow = A . exp >= B . exp + 1 ? B : A$$

$$anchor = A . exp >= B . exp + 1 ? A : B$$

$$rshf\_amt = \vert A . exp - ( B . exp + 1 ) \vert$$

In the case of forwarding with cancellation, the following operations determine the follow/anchor:

$$follow = A . exp >= B . exp - LZA ? B : A$$

$$anchor = A . exp >= B . exp - LZA ? A : B$$

and the shifting may depend on which term is the anchor, A or B (forwarded in this case). If A is the anchor, then A does not shift and B is shifted (either left or right by circuitry 130 or 212) based on the leading zero anticipation result:

$$If LZA > A . exp - B . exp$$

$$Ishf\_amt = LZA - ( A . exp - B . exp )$$

$$Else : ( LZA < A . exp - B . exp )$$

$$rshf\_amt = ( A . exp - B . exp ) - LZA$$

If B is the anchor, then B needs a left shift by the leading zero anticipation result and A needs a right shift based on the A and B exponents and the leading zero anticipation result:

$$Ishf\_amt = LZA$$

$$rshf\_amt = ( A . exp - B . exp ) - A . exp$$

Shift select circuitry 208, in the illustrated example, is configured to select either the B/forwarded mantissa or the A mantissa depending on which is being right-shifted. Guard/round/sticky circuitry 214, in this example, is configured to generate rounding bits based on bits shifted out of right-shifter 212. Round circuitry 238 is configured to store this information for the next cycle, in the illustrated example, and appropriately provide a carry-in bit to compound adder 240 if needed. Negate circuitry 120, in some embodiments, is configured to negate the follow mantissa, e.g., for subtraction operations.

LZA circuitry 246, in the illustrated embodiment, is configured to perform leading zero anticipation. Note that in some situations, the LZA may be 1 less than the correct value. If this occurs, circuitry 120 may control the shifters to left shift the anchor and follow term by an additional 1 bit (after all other shifts) to correct for this magnitude error (e.g., performed by LZA correction circuitry 222, 224, and 226). In some embodiments, such LZA an error is detected after the left shift on B finishes. If the MSB is not 1, this indicates an LZA error (ignoring subnormal cases). Because this error detection may happens so late in the cycle, this illustrated example does not try to incorporate the correction into the shifts at 130 and 212, but rather assumes that a separate optional shift by 1 may be needed on both the anchor and follow terms. Other potential LZA error cases may be handled naturally and may not need special handling. For example, because of how the anchor term comparison is formulated, A may be selected on the equivalent magnitude case. Therefore, if an LZA error occurs, the correct anchor is still selected. In some embodiments, the LZA correction scenario may also provide an adjustment of the anchor exponent (e.g., a decrement by one, not shown in the diagram).

Note that while traditional adder implementations may include circuitry similar to right-shift circuitry 212, the calculations by circuitry 120 for determining the right-shift amount are non-traditional, in various embodiments, e.g., to accommodate disclosed LZA and forwarding techniques.

Overflow circuitry 248, in the illustrated example, is configured to detect overflow and appropriately shift the output of compound adder 240 if needed. The overflow result is the intermediate mantissa value forwarded to forward select circuitry 204, in this example.

Left-shift circuitry 250, in some embodiments, is configured to left-shift the output of overflow handling 248 if needed. Output condition/special case circuitry 260, in the illustrated example, is configured to handle various special values (e.g., NaN, positive or negative infinity, etc.), error conditions, or some combination thereof and generate a final result for a given floating-point add instruction.

In various embodiments, the forward paths to circuitry 202, 204, 206, and 208 along with operations by exponent calculation circuitry 120 and corrections by LZA correction circuitry 222, 224, and 226 may facilitate various performance advantages discussed herein.

Note that disclosed techniques may provide fully accurate and correctly rounded operations for two dependent add operations, according to some accuracy and correctness criteria (e.g., according to an IEEE standard). This may be advantageous, at least for some workloads, relative to techniques that simply sacrifice accuracy or rounding correctness to achieve timing goals. Further note that, due to the commutative nature of addition, disclosed techniques may be applied regardless of which source operand has the dependency. For example, control circuitry (not shown) may be configured to swap the sources depending on which source has the dependency.

### Implementations with Longer Pipelines and Other Applications

FIG. 2 shows a two-stage pipeline with results from the first stage latched into circuitry 232, 234, 236, 238, and 242. In this context, disclosed techniques eliminate bubbles between dependent add instructions, in some embodiments. Note that disclosed techniques may also be used in longer pipelines to reduce bubbling. For example, in a three-cycle pipeline, disclosed forwarding techniques may have a worst-case stall of one cycle, in contrast to a two cycle stall using traditional techniques.

Further, disclosed techniques may also be used for a chain of floating-point adds for a sum reduction (e.g., in matrix multiplier circuitry configured to perform dot product and accumulate operations). In these applications, eliminating bubbles between accumulation operations may substantially improve performance.

Note that disclosed techniques may also be implemented in multi-path (e.g., dual path) adder architectures. Although specific single-path architectures are disclosed, they are not intended to limit the scope of the present disclosure. In other embodiments, various other adder topologies may utilize disclosed forwarding of intermediate results and shift techniques.

Still further, disclosed techniques may be implemented for applications such as a sum reduction that use multiple adder instances that operate on results from other instances (e.g., result=(A0+A1)+A2 and so on). In these implementations the forwarding case may always be selected and forward circuitry 202, 204, and 206 may be omitted. In these embodiments, a first add pipeline may perform a first add operation and a second add pipeline may perform a second add operation that is dependent on the first add operation. The second add pipeline may receive the various forwarded information of FIG. 2, but from the first add pipeline instead of from itself.

### Example Adder Implementation with Shared Left-Shift Circuitry

FIG. 3 is a block diagram illustrating a more detailed example of floating-point adder circuitry that shares left-shift circuitry for handling forwarded intermediate results and generating a final result, according to some embodiments. The embodiment of FIG. 3 may be utilized for adder applications where add instructions need to either provide a final result (e.g., the output of circuitry 260) or a forwarded intermediate result (e.g., via the dashed arrows), but not both. In this context, the left-shifter 130 is unused when not forwarding from a previous instruction, and therefore can be shared for traditional left shifts and left shifts for forwarding, depending on the type of output for a given instruction. Note that this shifter use may be understood more clearly based on the set case analysis discussed above, which shows the various forwarding scenarios and when shifting is needed.

In the illustrated example, the intermittent dashed and dotted line from the output of shifter 130 to circuitry 260 corresponds to use of shifter 130 in the non-forward scenario, e.g., to perform the traditional left-shift of the output of overflow handler circuitry 248 (e.g., selected by MUX 204) as a result to be processed and output by circuitry 260. In this scenario, circuitry 120 may set the left shift amount to the LZA value. In contrast, in forwarding scenarios, circuitry 120 is configured to control left-shifter 130 to shift the intermediate result (e.g., according to the set case analysis above) and provide the output to anchor select MUX 216 and follow select MUX 218 for use by the next instruction.

Therefore, in these embodiments, left-shifter 130 is shared for forwarding and non-forwarding scenarios and may further reduce area and power consumption, for certain applications, relative to the embodiment of FIG. 2.

### Example Method

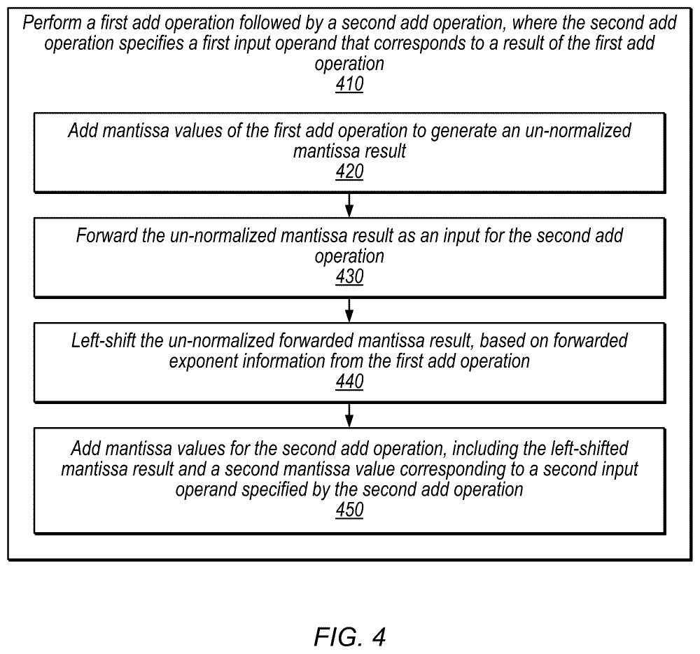

FIG. 4 is a flow diagram illustrating an example method for executing add operations with a dependency, according to some embodiments. The method shown in FIG. 4 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 410, in the illustrated embodiment, floating-point add pipeline circuitry of a computing system performs a first add operation followed by a second add operation, where the second add operation specifies a first input operand that corresponds to a result of the first add operation. In the illustrated example, this includes elements 420-450.

At 420, in the illustrated embodiment, the circuitry (e.g., compound adder 240) adds mantissa values of the first add operation to generate an un-normalized, intermediate mantissa result.

At 430, in the illustrated embodiment, the circuitry forwards (e.g., from circuitry 248) the un-normalized mantissa result as an input for the second add operation (and may also forward other information such as sign, exponent, LZA, and overflow information).

At 440, in the illustrated embodiment, the circuitry left-shifts (e.g., by left-shifter 130) the un-normalized forwarded mantissa result, based on forwarded exponent information from the first add operation. In some embodiment, right-shift circuitry (e.g., 212) is configured to right shift a second input operand of the second add operation. The right shift and the left shift may be performed at least partially in parallel, in the same clock cycle, or both.

Note that this shift scenario may be one of multiple shift scenarios supported by the shift circuitry. For example, various additional scenarios are discussed above with reference to the set case analysis. This particular scenario may be particularly relevant in hiding latency relating to normalization.

At 450, in the illustrated embodiment, the circuitry adds (e.g., by compound adder 240) mantissa values for the second add operation, including the left-shifted mantissa result and a second mantissa value corresponding to a second input operand specified by the second add operation.

In some embodiments, the forwarded exponent information is an exponent selected as an anchor (e.g., from circuitry 232).

In some embodiments, the intermediate forwarded mantissa value is forwarded prior to normalization (e.g., by left-shifter 250) of the mantissa result generated by the adder circuitry. In some embodiments, the intermediate forwarded mantissa value is generated by overflow control circuitry (e.g., 248) configured to shift the mantissa result from the adder circuitry based on an overflow signal.

In some embodiments, leading zero error control circuitry (e.g., circuitry 236, 120, 222, 224, and 226) is configured to determine that a forwarded result has been selected as an anchor term for the second add operation, detect that a leading zero anticipator result for the second add operation is less than a correct value, and in response to the determination and detection, perform one or more shift operations to correct the leading zero anticipator result.

In some embodiments (e.g., the embodiment of FIG. 3), control circuitry is configured to determine whether a given add operation utilizes a forwarded un-normalized mantissa result and control the left-shift circuitry. Specifically, for a non-forwarding add operation, the left-shift circuitry may normalize the mantissa result from the adder circuitry to generate a final result of the non-forwarding add operation. For an add operation that utilizes a forwarded un-normalized mantissa result, the left-shift circuitry may left-shift the un-normalized forwarded mantissa result, as described above. Therefore, the left-shift circuitry may be shared for operations with and without forwarding, in some embodiments.

In some embodiments, exponent control circuitry (e.g., circuitry 120) is configured to control the left-shift circuitry based on: the forwarded exponent information, an exponent of a second input operand, a leading zero anticipator result, and an overflow result. In some embodiments, sign forward circuitry is configured to forward an intermediate sign result of the first add operation (e.g., from circuitry 242).

In some embodiments, the floating-point add pipeline circuitry is configured to perform the second add operation immediately following the first add operation without any pipeline bubbles. In other embodiments, the floating-point add pipeline circuitry implements an N-stage pipeline, is configured to perform the second add operation immediately following the first add operation, and utilizes at most N-2 pipeline bubbles between the first and second add operations. For example, a 3-stage pipeline may utilize one bubble, a 4-stage pipeline two bubbles, etc.

### Example Device

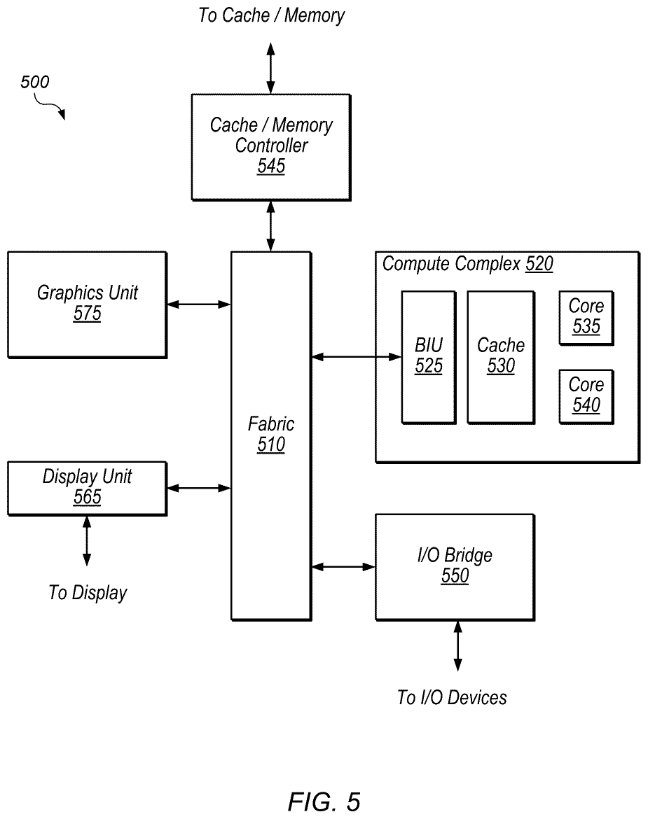

Referring now to FIG. 5, a block diagram illustrating an example embodiment of a device 500 is shown. In some embodiments, elements of device 500 may be included within a system on a chip. In some embodiments, device 500 may be included in a mobile device, which may be battery-powered. Therefore, power consumption by device 500 may be an important design consideration. In the illustrated embodiment, device 500 includes fabric 510, compute complex 520 input/output (I/O) bridge 550, cache/memory controller 545, graphics unit 575, and display unit 565. In some embodiments, device 500 may include other components (not shown) in addition to or in place of the illustrated components, such as video processor encoders and decoders, image processing or recognition elements, computer vision elements, etc.

Fabric 510 may include various interconnects, buses, MUX's, controllers, etc., and may be configured to facilitate communication between various elements of device 500. In some embodiments, portions of fabric 510 may be configured to implement various different communication protocols. In other embodiments, fabric 510 may implement a single communication protocol and elements coupled to fabric 510 may convert from the single communication protocol to other communication protocols internally.

In the illustrated embodiment, compute complex 520 includes bus interface unit (BIU) 525, cache 530, and cores 535 and 540. In various embodiments, compute complex 520 may include various numbers of processors, processor cores and caches. For example, compute complex 520 may include 1, 2, or 4 processor cores, or any other suitable number. In one embodiment, cache 530 is a set associative L2 cache. In some embodiments, cores 535 and 540 may include internal instruction and data caches. In some embodiments, a coherency unit (not shown) in fabric 510, cache 530, or elsewhere in device 500 may be configured to maintain coherency between various caches of device 500. BIU 525 may be configured to manage communication between compute complex 520 and other elements of device 500. Processor cores such as cores 535 and 540 may be configured to execute instructions of a particular instruction set architecture (ISA) which may include operating system instructions and user application instructions. These instructions may be stored in computer readable medium such as a memory coupled to memory controller 545 discussed below.

In some embodiments, a given processor core is configured to execute add instructions using disclosed adder circuitry. For example, the processor core may include an execution pipeline to fetch, decode, and dispatch instructions and one or more ALUs may include disclosed adder circuitry for add instructions.

As used herein, the term “coupled to” may indicate one or more connections between elements, and a coupling may include intervening elements. For example, in FIG. 5, graphics unit 575 may be described as “coupled to” a memory through fabric 510 and cache/memory controller 545. In contrast, in the illustrated embodiment of FIG. 5, graphics unit 575 is “directly coupled” to fabric 510 because there are no intervening elements.

Cache/memory controller 545 may be configured to manage transfer of data between fabric 510 and one or more caches and memories. For example, cache/memory controller 545 may be coupled to an L3 cache, which may in turn be coupled to a system memory. In other embodiments, cache/memory controller 545 may be directly coupled to a memory. In some embodiments, cache/memory controller 545 may include one or more internal caches. Memory coupled to controller 545 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 545 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 520 to cause the computing device to perform functionality described herein.

Graphics unit 575 may include one or more processors, e.g., one or more graphics processing units (GPUs). Graphics unit 575 may receive graphics-oriented instructions, such as OPENGL®, Metal®, or DIRECT3D® instructions, for example. Graphics unit 575 may execute specialized GPU instructions or perform other operations based on the received graphics-oriented instructions. Graphics unit 575 may generally be configured to process large blocks of data in parallel and may build images in a frame buffer for output to a display, which may be included in the device or may be a separate device. Graphics unit 575 may include transform, lighting, triangle, and rendering engines in one or more graphics processing pipelines. Graphics unit 575 may output pixel information for display images. Graphics unit 575, in various embodiments, may include programmable shader circuitry which may include highly parallel execution cores configured to execute graphics programs, which may include pixel tasks, vertex tasks, and compute tasks (which may or may not be graphics-related).

In some embodiments, graphics unit 575 is configured to perform add operations using disclosed adder circuitry. For example, shader circuitry may include ALUs configured to execute single-instruction multiple thread (SIMT) groups that include add instructions. As another example, matrix accelerator circuitry (in graphics unit 575 or elsewhere in the system) may implement disclosed adder circuitry, e.g., for dot product accumulate operations.

Display unit 565 may be configured to read data from a frame buffer and provide a stream of pixel values for display. Display unit 565 may be configured as a display pipeline in some embodiments. Additionally, display unit 565 may be configured to blend multiple frames to produce an output frame. Further, display unit 565 may include one or more interfaces (e.g., MIPI® or embedded display port (eDP)) for coupling to a user display (e.g., a touchscreen or an external display).

I/O bridge 550 may include various elements configured to implement: universal serial bus (USB) communications, security, audio, and low-power always-on functionality, for example. I/O bridge 550 may also include interfaces such as pulse-width modulation (PWM), general-purpose input/output (GPIO), serial peripheral interface (SPI), and inter-integrated circuit (I2C), for example. Various types of peripherals and devices may be coupled to device 500 via I/O bridge 550.

In some embodiments, device 500 includes network interface circuitry (not explicitly shown), which may be connected to fabric 510 or I/O bridge 550. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 500 with connectivity to various types of other devices and networks.

### Example Applications

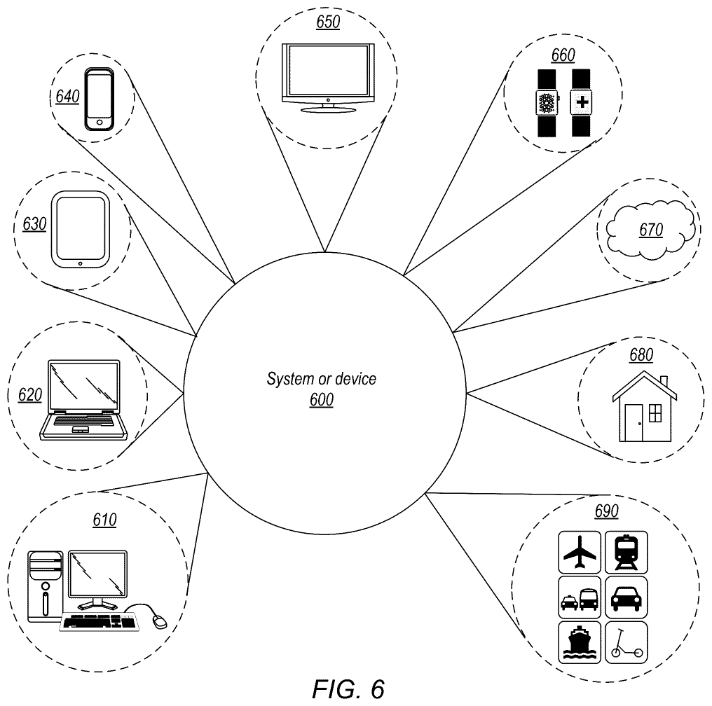

Turning now to FIG. 6, various types of systems that may include any of the circuits, devices, or system discussed above. System or device 600, which may incorporate or otherwise utilize one or more of the techniques described herein, may be utilized in a wide range of areas. For example, system or device 600 may be utilized as part of the hardware of systems such as a desktop computer 610, laptop computer 620, tablet computer 630, cellular or mobile phone 640, or television 650 (or set-top box coupled to a television).

Similarly, disclosed elements may be utilized in a wearable device 660, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 600 may also be used in various other contexts. For example, system or device 600 may be utilized in the context of a server computer system, such as a dedicated server or on shared hardware that implements a cloud-based service 670. Still further, system or device 600 may be implemented in a wide range of specialized everyday devices, including devices 680 commonly found in the home such as refrigerators, thermostats, security cameras, etc. The interconnection of such devices is often referred to as the “Internet of Things” (IoT). Elements may also be implemented in various modes of transportation. For example, system or device 600 could be employed in the control systems, guidance systems, entertainment systems, etc. of various types of vehicles 690.

The applications illustrated in FIG. 6 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

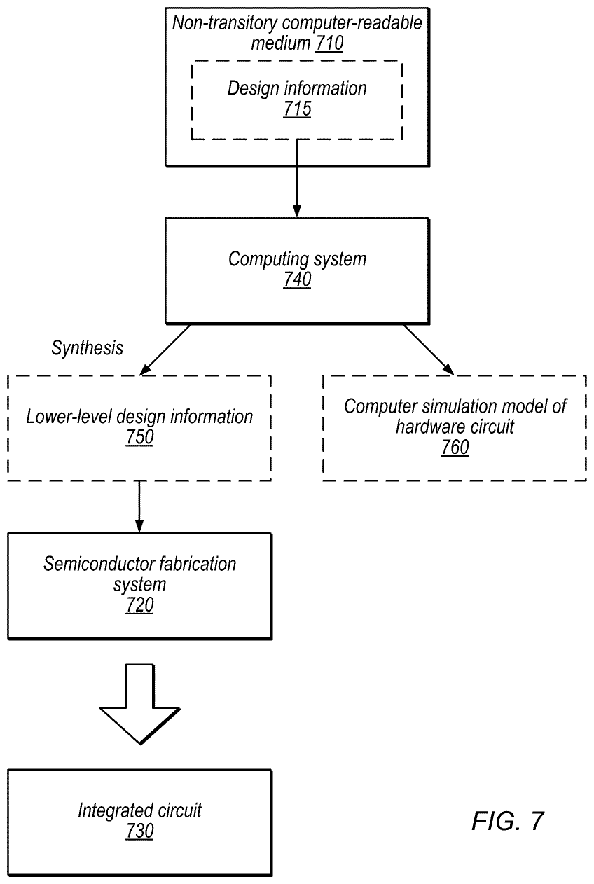

FIG. 7 is a block diagram illustrating an example non-transitory computer-readable storage medium that stores circuit design information, according to some embodiments. In the illustrated embodiment, computing system 740 is configured to process the design information. This may include executing instructions included in the design information, interpreting instructions included in the design information, compiling, transforming, or otherwise updating the design information, etc. Therefore, the design information controls computing system 740 (e.g., by programming computing system 740) to perform various operations discussed below, in some embodiments.

In the illustrated example, computing system 740 processes the design information to generate both a computer simulation model of a hardware circuit 760 and lower-level design information 750. In other embodiments, computing system 740 may generate only one of these outputs, may generate other outputs based on the design information, or both. Regarding the computing simulation, computing system 740 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 740 also processes the design information to generate lower-level design information 750 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 750 (potentially among other inputs), semiconductor fabrication system 720 is configured to fabricate an integrated circuit 730 (which may correspond to functionality of the simulation model 760). Note that computing system 740 may generate different simulation models based on design information at various levels of description, including information 750, 715, and so on. The data representing design information 750 and model 760 may be stored on medium 710 or on one or more other media.

In some embodiments, the lower-level design information 750 controls (e.g., programs) the semiconductor fabrication system 720 to fabricate the integrated circuit 730. Thus, when processed by the fabrication system, the design information may program the fabrication system to fabricate a circuit that includes various circuitry disclosed herein.

Non-transitory computer-readable storage medium 710, may comprise any of various appropriate types of memory devices or storage devices. Non-transitory computer-readable storage medium 710 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 710 may include other types of non-transitory memory as well or combinations thereof. Accordingly, non-transitory computer-readable storage medium 710 may include two or more memory media; such media may reside in different locations—for example, in different computer systems that are connected over a network.

Design information 715 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 740, semiconductor fabrication system 720, or both. In some embodiments, design information may also include one or more cell libraries that specify the synthesis, layout, or both of integrated circuit 730. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 730 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 720 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 720 may also be configured to perform various testing of fabricated circuits for correct operation.

In various embodiments, integrated circuit 730 and model 760 are configured to operate according to a circuit design specified by design information 715, which may include performing any of the functionality described herein. For example, integrated circuit 730 may include any of various elements shown in FIGS. 1-3 and 5 Further, integrated circuit 730 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 720 to fabricate integrated circuit 730.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may be written in a compiled language such as C or C++, or an interpreted language such as JavaScript.

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. An apparatus, comprising:
floating-point add pipeline circuitry configured to perform a first add operation followed by a second add operation, wherein the second add operation specifies a first input operand that corresponds to a result of the first add operation, comprising:
adder circuitry configured to add mantissa values to generate a mantissa result;
forward circuitry configured to forward:
an un-normalized mantissa result from the adder circuitry as an input operand for the second add operation; and
exponent information from the first add operation; and
left-shift circuitry, prior to the adder circuitry in the pipeline, configured to left-shift the un-normalized mantissa result based on the exponent information, wherein the adder circuitry is configured to add the shifted mantissa result for the second add operation.

2. The apparatus of claim 1, further comprising:
right-shift circuitry configured to right shift a second input operand of the second add operation;
wherein the right shift and the left shift are performed at least partially in parallel in the same clock cycle.

3. The apparatus of claim 1, wherein the un-normalized forwarded mantissa value is generated by overflow control circuitry configured to shift the mantissa result from the adder circuitry based on an overflow signal.

4. The apparatus of claim 1, further comprising:
leading zero error control circuitry configured to:
determine that a forwarded result has been selected as an anchor term for the second add operation;
detect that a leading zero anticipator result for the second add operation is less than a correct value; and
in response to the determination and detection, perform one or more shift operations to correct the leading zero anticipator result.

5. The apparatus of claim 1, wherein the forwarded exponent information is an exponent selected as an anchor.

6. The apparatus of claim 1, further comprising control circuitry configured to:
determine whether a given add operation utilizes a forwarded un-normalized mantissa result; and
control the left-shift circuitry to:
for a non-forwarding add operation, control the left-shift circuitry to normalize a mantissa result from the adder circuitry; and
for an add operation that utilizes a forwarded un-normalized mantissa result, control the left-shift circuitry to left-shift the un-normalized forwarded mantissa result.

7. The apparatus of claim 1, further comprising:
exponent control circuitry configured to control the left-shift circuitry based on:
the forwarded exponent information;
an exponent of a second input operand of the second add operation;
a leading zero anticipator result; and
an overflow result.

8. The apparatus of claim 1, further comprising:
sign forward circuitry configured to forward an intermediate sign result of the first add operation.

9. The apparatus of claim 1, wherein the floating-point add pipeline circuitry is configured to perform the second add operation immediately following the first add operation without any pipeline bubbles.

10. The apparatus of claim 1, wherein the floating-point add pipeline circuitry:
implements an N-stage pipeline;
is configured to perform the second add operation immediately following the first add operation; and
utilizes at most N-2 pipeline bubbles between the first and second add operations.

11. The apparatus of claim 1, wherein the apparatus is a computing device that further includes:
a display; and
network interface circuitry.

12. A method, comprising:
performing, by floating-point add pipeline circuitry of a computing system, a first add operation followed by a second add operation, wherein the second add operation specifies a first input operand that corresponds to a result of the first add operation, wherein the performing includes:
adding mantissa values for the first add operation to generate an un-normalized intermediate mantissa result;
forwarding the un-normalized mantissa result as an input for the second add operation;
left-shifting the un-normalized forwarded mantissa result, based on forwarded exponent information from the first add operation; and
adding mantissa values for the second add operation, including the left-shifted mantissa result and a second mantissa value corresponding to a second input operand specified by the second add operation.

13. The method of claim 12, wherein the un-normalized mantissa result is corrected prior to the forwarding based on an overflow signal.

14. The method of claim 12, wherein the performing further includes
determining that a forwarded result has been selected as an anchor term for the second add operation;
detecting that a leading zero anticipator result for the second add operation is less than a correct value; and
in response to the determining and detecting, performing one or more shift operations to correct the leading zero anticipator result.

15. The method of claim 12, further comprising:
using left-shift circuitry to perform the left-shifting; and
using the left-shift circuitry to left-shift a mantissa result for a third add operation that does not use any forwarded input operand.

16. The method of claim 12, further comprising:
determining a left-shift amount for the left-shifting based on:
the forwarded exponent information;
an exponent of a second input operand;
a leading zero anticipator result; and
an overflow result.

17. The method of claim 12, wherein the performing performs the second add operation immediately following the first add operation without any pipeline bubbles.

18. A non-transitory computer-readable medium having instructions of a hardware description programming language stored thereon that, when processed by a computing system, program the computing system to generate a computer simulation model, wherein the model represents a hardware circuit that includes:
floating-point add pipeline circuitry configured to perform a first add operation followed by a second add operation, wherein the second add operation specifies a first input operand that corresponds to a result of the first add operation, comprising:
adder circuitry configured to add mantissa values to generate a mantissa result;
forward circuitry configured to provide:
an un-normalized mantissa result from the adder circuitry as an input operand for the second add operation; and
exponent information from the first add operation; and
left-shift circuitry, prior to the adder circuitry in the pipeline, configured to left-shift the un-normalized mantissa result based on the exponent information, wherein the adder circuitry is configured to add the shifted mantissa result for the second add operation.

19. The non-transitory computer-readable medium of claim 18, further comprising:
right-shift circuitry configured to right-shift a second input operand of the second add operation;
wherein the right-shift and the left shift are performed at least partially in parallel.

20. The non-transitory computer-readable medium of claim 18, wherein the circuit further includes:
leading zero error control circuitry configured to:
determine that a forwarded result has been selected as an anchor term for the second add operation;
detect that a leading zero anticipator result for the second add operation is less than a correct value; and
in response to the determination and detection, perform one or more shift operations to correct the leading zero anticipator result.
